(19) United States
(12) Patent Application Publication
(10) Pub. No.: US 2015/0223505 A1
(43) Pub. Date: Aug. 13, 2015

(54) STEVIA COMPOSITION, PRODUCTION METHOD AND USES

(71) Applicant: PureCircle USA Inc., Oak Brook, IL (US)

(72) Inventor: Avetik MARKOSYAN, Yerevan (AM)

(21) Appl. No.: 14/606,612

(22) Filed: Jan. 27, 2015

Related U.S. Application Data
(60) Provisional application No. 61/938,736, filed on Feb. 12, 2014.

(51) Int. Cl. A23L 1/236

(52) U.S. Cl. CPC A23L 1/2366; A23V 2002/00

(57) ABSTRACT

Stevia compositions are prepared from Stevia rebaudiana Bertoni. The compositions are able to provide a superior taste profile and can be used as sweeteners, sweetness enhancers, flavors, flavor enhancers in foods, beverages, cosmetics and pharmaceuticals.

### BACKGROUND OF THE INVENTION

1. Field of the Invention

The invention relates to a process for producing a purified food ingredient from the Stevia rebaudiana Bertoni plant and its use in various food products and beverages.

2. Description of the Related Art

Nowadays sugar alternatives are receiving increasing attention due to awareness of many diseases in conjunction with consumption of high-sugar foods and beverages. However many artificial sweeteners such as dulcin, sodium cyclamate and saccharin were banned or restricted in some countries due to concerns on their safety. Therefore non-caloric sweeteners of natural origin are becoming increasingly popular. The sweet herb Stevia rebaudiana Bertoni, produces a number of diterpene glycosides which feature high intensity sweetness and sensory properties superior to those of many other high potency sweeteners.

The above-mentioned sweet glycosides, have a common aglycon, steviol, and differ by the number and type of carbohydrate residues at the C13 and C19 positions. The leaves of Stevia are able to accumulate up to 10-20% (on dry weight basis) steviol glycosides. The major glycosides found in Stevia leaves are rebaudioside A (2-10%), stevioside (2-10%), and rebaudioside C (1-2%). Other glycosides such as rebaudioside B, D, E, and F, steviolbioside and rubusoside are found at much lower levels (approx. 0-0.2%).

Two major glycosides—stevioside and rebaudioside A (reb A), were extensively studied and characterized in terms of their suitability as commercial high intensity sweeteners. Stability studies in carbonated beverages confirmed their heat and pH stability (Chang S. S., Cook, J. M. (1983) Stability studies of stevioside and rebaudioside A in carbonated beverages. J. Agric. Food Chem. 31: 409-412.)

Steviol glycosides differ from each other not only by molecular structure, but also by their taste properties. Usually stevioside is found to be 110-270 times sweeter than sucrose, rebaudioside A between 150 and 320 times, and rebaudioside C between 40-60 times sweeter than sucrose. Dulcoside A is 30 times sweeter than sucrose. Rebaudioside A has the least astringent, the least bitter, and the least persistent aftertaste thus possessing the most favorable sensory attributes in major steviol glycosides (Tanaka O. (1987) Improvement of taste of natural sweetners. Pure Appl. Chem. 69:675-683; Phillips K. C. (1989) Stevia: steps in developing a new sweetener. In: Grenby T. H. ed. Developments in sweeteners, vol. 3. Elsevier Applied Science, London. 1-43.) The chemical structure of rebaudioside A is shown in FIG. 1.

Methods for the extraction and purification of sweet glycosides from the Stevia rebaudiana plant using water or organic solvents are described in, for example, U.S. Pat. Nos. 4,361,697; 4,082,858; 4,892,938; 5,972,120; 5,962,678; 7,838,044 and 7,862,845.

However, even in a highly purified state, steviol glycosides still possess undesirable taste attributes such as bitterness, sweet aftertaste, licorice flavor, etc. One of the main obstacles for the successful commercialization of stevia sweeteners are these undesirable taste attributes. It was shown that these flavor notes become more prominent as the concentration of steviol glycosides increases (Prakash I., DuBois G. E., Clos J. F., Wilkens K. L., Fosdick L. E. (2008) Development of rebiana, a natural, non-caloric sweetener. Food Chem. Toxicol., 46, S75-S82.).

Several methods are described in literature for preparing purified steviol glycosides composition.

According to JECFA 2010 description typical process of steviol glycosides composition can be described as follows.

“The product [steviol glycosides] is obtained from the leaves of Stevia rebaudiana Bertoni. The leaves are extracted with hot water and the aqueous extract is passed through an adsorption resin to trap and concentrate the component steviol glycosides. The resin is washed with a solvent alcohol to release the glycosides and the product is recrystallized from methanol or aqueous ethanol. Ion-exchange resins may be used in the purification process. The final product may be spray-dried” (prepared at the 73^{rd} JECFA (2010) and published in FAO JECFA Monographs 10 (2010)).

As it can be seen the process involves several steps some of which employ ion-exchange resins for desalting the obtained extract, and crystallizing from organic solvents.

Within the description of this invention we will show that, the process of the invention allows to reduce or completely eliminate the usage of organic solvents in purification process of steviol glycosides. The invention provides alternative method which introduces new techniques not described in prior art for steviol glycosides purification.

Moreover the methods of the invention can be used in purification of other glycosides (e.g. Luo Han Guo glycosides).

### SUMMARY OF THE INVENTION

The present invention is aimed to overcome the disadvantages of existing steviol glycoside purification process.

The invention, in part, pertains to an ingredient comprising steviol glycosides of Stevia rebaudiana Bertoni plant. The steviol glycodsides are selected from the group consisting of stevioside, rebaudioside A, rebaudioside B, rebaudioside C, rebaudioside D, rebaudioside E, rebaudioside F, rebaudioside M, rebaudioside N, rebaudioside O, dulcoside A, steviolbioside, rubusoside, as well as other steviol glycosides found in Stevia rebaudiana Bertoni plant, glycosylated steviol glycosides and mixtures thereof.

The invention, in part, pertains to a process for producing an ingredient containing rebaudioside A, stevioside, rebaudioside B, rebaudioside C, rebaudioside D, rebaudioside E, rebaudioside F, rebaudioside M, rebaudioside N, rebaudioside O, dulcoside A, steviolbioside, rubusoside, as well as other steviol glycosides found in Stevia rebaudiana Bertoni plant, glycosylated steviol glycosides and mixtures thereof.

The starting material is an aqueous or aqueous alcohol solution containing one or more glycosides of steviol—steviol glycosides solution.

The steviol glycosides solution is mixed with one or more salts, until complete dissolution.

The process may optionally include addition of one or more acids, and/or one or more bases into solution.

The obtained solution is kept until the steviol glycosides crystallize.

Then the steviol glycosides crystals are separated from the solution to produce a composition comprising one or more glycosides of steviol.

The compositions can be used as sweeteners, sweetness enhancers, flavors and flavor enhancers in various food and beverage products. Non-limiting examples of food and beverage products include carbonated soft drinks, ready to drink beverages, energy drinks, isotonic drinks, low-calorie drinks, zero-calorie drinks, sports drinks, teas, fruit and vegetable juices, juice drinks, dairy drinks, yoghurt drinks, alcohol beverages, powdered beverages, bakery products, cookies, biscuits, baking mixes, cereals, confectioneries, candies, toffees, chewing gum, dairy products, flavored milk, yoghurts, flavored yoghurts, cultured milk, soy sauce and other soy base products, salad dressings, mayonnaise, vinegar, frozen-desserts, meat products, fish-meat products, bottled and canned foods, tabletop sweeteners, fruits and vegetables.

Additionally the compositions can be used in drug or pharmaceutical preparations and cosmetics, including but not limited to toothpaste, mouthwash, cough syrup, chewable tablets, lozenges, vitamin preparations, and the like.

The compositions can be used “as-is” or in combination with other sweeteners, flavors and food ingredients.

Non-limiting examples of sweeteners include steviol glycosides, stevioside, rebaudioside A, rebaudioside B, rebaudioside C, rebaudioside D, rebaudioside E, rebaudioside F, rebaudioside M, rebaudioside N, rebaudioside O, dulcoside A, steviolbioside, rubusoside, as well as other steviol glycosides found in Stevia rebaudiana Bertoni plant and mixtures thereof, stevia extract, glycosylated steviol glycosides, Luo Han Guo extract, mogrosides, glycosylated mogrosides, high-fructose corn syrup, corn syrup, invert sugar, fructooligosaccharides, inulin, inulooligosaccharides, coupling sugar, maltooligosaccharides, maltodextins, corn syrup solids, glucose, maltose, sucrose, lactose, aspartame, saccharin, sucralose, sugar alcohols.

Non-limiting examples of flavors include lemon, orange, fruit, banana, grape, pear, pineapple, bitter almond, cola, cinnamon, sugar, cotton candy, vanilla flavors.

Non-limiting examples of other food ingredients include flavors, acidulants, organic and amino acids, coloring agents, bulking agents, modified starches, gums, texturizers, preservatives, antioxidants, emulsifiers, stabilisers, thickeners, gelling agents.

We claim:

1. A process for producing a steviol glycosides composition, comprising the steps of:
providing a solution containing at least one glycoside of steviol;
providing at least one salt;
dissolving the salt to form a mixture;
incubating the mixture to obtain a precipitate;
separating the precipitate.

2. The process of claim 1 further comprising the steps of:
drying the precipitate to obtain a steviol glycosides composition;
wherein the steviol glycosides composition comprises at least one glycoside of steviol.

3. A sweetener composition comprising steviol glycosides composition made by the process of claim 1, and an additional sweetening agent selected from the group consisting of: stevia extract, steviol glycosides, stevioside, rebaudioside A, rebaudioside B, rebaudioside C, rebaudioside D, rebaudioside E, rebaudioside F, rebaudioside M, rebaudioside N, rebaudioside O, dulcoside A, steviolbioside, rubusoside, other steviol glycosides found in Stevia rebaudiana Bertoni plant and mixtures thereof, glycosylated steviol glycosides, Luo Han Guo extract, mogrosides, glycosylated mogrosides, high-fructose corn syrup, corn syrup, invert sugar, fructooligosaccharides, inulin, inulooligosaccharides, coupling sugar, maltooligosaccharides, maltodextins, corn syrup solids, glucose, maltose, sucrose, lactose, aspartame, saccharin, sucralose, sugar alcohols, and a combination thereof.

4. A flavor composition comprising a steviol glycosides composition made by the process of claim 1, and an additional flavoring agent selected from the group consisting of: lemon, orange, fruit, banana, grape, pear, pineapple, mango, bitter almond, cola, cinnamon, sugar, cotton candy, vanilla, and a combination thereof.

5. A food ingredient comprising a steviol glycosides composition made by the process of claim 1 and an additional food ingredient selected from the group consisting of: acidulants, organic and amino acids, coloring agents, bulking agents, modified starches, gums, texturizers, preservatives, antioxidants, emulsifiers, stabilisers, thickeners, gelling agents, and a combination thereof.

6. A food, beverage, cosmetic or pharmaceutical product comprising a steviol glycosides composition made by the process of claim 1.
